(19) United States
(12) Patent Application Publication
(10) Pub. No.: US 2026/0316323 A1
(43) Pub. Date: Oct. 15, 2026

(54) Drill, in Particular a Wood Drill

(71) Applicant: Robert Bosch GmbH, Stuttgart (DE)

(72) Inventor: Stefan Christen, Langendorf (CH)

(21) Appl. No.: 19/100,407

(22) PCT Filed: Jul. 27, 2023
(86) PCT No.: PCT/EP2023/070836

§ 371 Date: Jan. 31, 2025

(30) Foreign Application Priority Data
Aug. 8, 2022 (DE) 10 2022 208 205.2

(51) Int. Cl. B27G 15/00

(52) U.S. Cl. CPC B27G 15/00

(57) ABSTRACT

A drill, in particular a wood drill, includes a longitudinal central axis and a clamping portion for a rotationally fixed connection to a tool holder. The clamping portion is connected via a shaft portion to a cutting portion that forms a head portion on an end facing away from the clamping portion. A centering portion is arranged on the head portion, and the head portion has a cutting edge with at least two interconnected portions, wherein a first portion is arranged at a predefined angle to a second portion. The first portion has a first diameter and the second portion has a second diameter, the second diameter being smaller than the first diameter. The first portion is arranged facing the clamping portion, and the second portion is arranged facing the centering portion.

### PRIOR ART

The present invention relates to a drill, in particular a wood drill, having a longitudinal central axis and a clamping portion for a rotationally fixed connection to a tool holder, wherein the clamping portion is connected via a shaft portion to a cutting portion that forms a head portion on an end facing away from the clamping portion, wherein a centering portion is arranged on the head portion.

Such a drill configured as a wood drill is known from the state of the art. The drill has a longitudinal central axis and a clamping portion for a rotationally fixed connection to a tool holder. The clamping portion is connected via a shaft portion to a cutting portion that forms a head portion at an end facing away from the clamping portion. A centering portion is arranged on the head portion. Due to new framework conditions for new types of power tools, higher torques exert greater forces on the drill, which can lead to comparatively faster wear.

### DISCLOSURE OF THE INVENTION

The invention relates to a drill, in particular a wood drill, having a longitudinal central axis and a clamping portion for a rotationally fixed connection to a tool holder, wherein the clamping portion is connected via a shaft portion to a cutting portion that forms a head portion on an end facing away from the clamping portion, wherein a centering portion is arranged on the head portion. The head portion has a cutting edge having at least two interconnected portions, wherein a first portion is arranged at a predefined angle to a second portion, wherein the first portion has a first diameter and the second portion has a second diameter, wherein the second diameter is smaller than the first diameter, and wherein the first portion is arranged facing the clamping portion and the second portion is arranged facing the centering portion.

The invention thus allows the provision of a drill having at least two portions of a cutting edge interconnected at a predefined angle, thereby reducing forces acting on the drill. This can reduce wear due to forces usually acting on the drill.

Preferably, the cutting portion has a first material and the head portion has a second material, wherein the two materials are different.

This makes it easy and straightforward to increase the material hardness and thus increase wear resistance.

The second material preferably comprises high-speed steel, high-strength carbon steel, and/or carbide.

This makes it easy to provide a second material with greater material hardness and improved wear resistance.

The head portion is preferably fixed to the cutting portion via a weld joint.

This enables a safe and reliable arrangement of the head portion on the cutting portion.

Preferably a predefined circumferential distance is formed between an outer circumference of the centering portion and an outer circumference of the head portion, wherein a ratio of a maximum outer diameter of the head portion to the predefined circumferential distance is smaller than 3.5.

Thus, an appropriate configuration of the head portion can be provided in a simple manner.

Preferably, the first portion has a height arranged perpendicular to the longitudinal central axis, wherein the height has a value in the range of 1.5 mm to 4 mm.

Thus, a suitable cutting edge or a first portion can be provided in a simple manner.

According to one embodiment, the head portion has a maximum external diameter of at least 17 mm.

Thus, a head portion may be provided with which the cutting edge may be easily and straightforwardly formed with at least two portions.

Preferably the cutting edge comprises the first portion, the second portion and a third portion, wherein the first portion is arranged at a predefined angle to the second portion and the third portion is arranged at a predefined angle to the second portion.

Thus, an alternative configuration may be provided in which wear due to forces usually acting on the drill may be at least reduced.

According to one embodiment, the cutting edge comprises a first step, which is arranged between the first and second portions, and a second step, which is arranged between the first and third portions, wherein the first step has a first length aligned along the longitudinal central axis and the second step has a second length aligned along the longitudinal central axis, wherein the first length is smaller than the second length.

Thus, a strictly monotonic cutting edge may be provided in a simple manner.

Preferably, a maximum outer diameter of the head portion is greater than an outer diameter of the shaft portion.

Thus, a suitable head portion for a drill may be provided in a simple manner.

### BRIEF DESCRIPTION OF THE DRAWINGS

The invention is explained in more detail in the following description with reference to the embodiment examples shown in the drawings. The figures show:

FIG. 1 a side view of a drill with a cutting edge according to the invention,

FIG. 2 a front view of the drill of FIG. 1,

FIG. 3 a top view of an enlarged area of the drill of FIG. 1 and FIG. 2,

FIG. 4 a perspective view of an enlarged area of the drill of FIG. 1 to FIG. 3,

FIG. 5 a perspective view of an enlarged area of the drill of FIG. 4, in a rotated view relative to FIG. 4,

FIG. 6 a front view of the drill of FIG. 1 with an alternative head portion,

FIG. 7 a top view of an enlarged area of the drill of FIG. 6,

FIG. 8 a perspective view of an enlarged area of the drill of FIG. 6 and FIG. 7,

FIG. 9 a perspective view of an enlarged area of the drill of FIG. 6 to FIG. 8 in a rotated view relative to FIG. 8,

FIG. 10 a partial longitudinal section through the drill of FIG. 1 to FIG. 5,

FIG. 11 a side view of the head portion of the drill of FIG. 1 to FIG. 5,

FIG. 12 a longitudinal section through the head portion of the drill of FIG. 1 to FIG. 5 with hardness measurement points, and

FIG. 13 a longitudinal section through a cutting edge with hardness measurement points associated with the head portion of the drill of FIG. 1 to FIG. 5.

### DESCRIPTION OF THE EMBODIMENT EXAMPLES

Elements having the same or a comparable function are provided with the same reference signs in the figures and are described in detail only once.

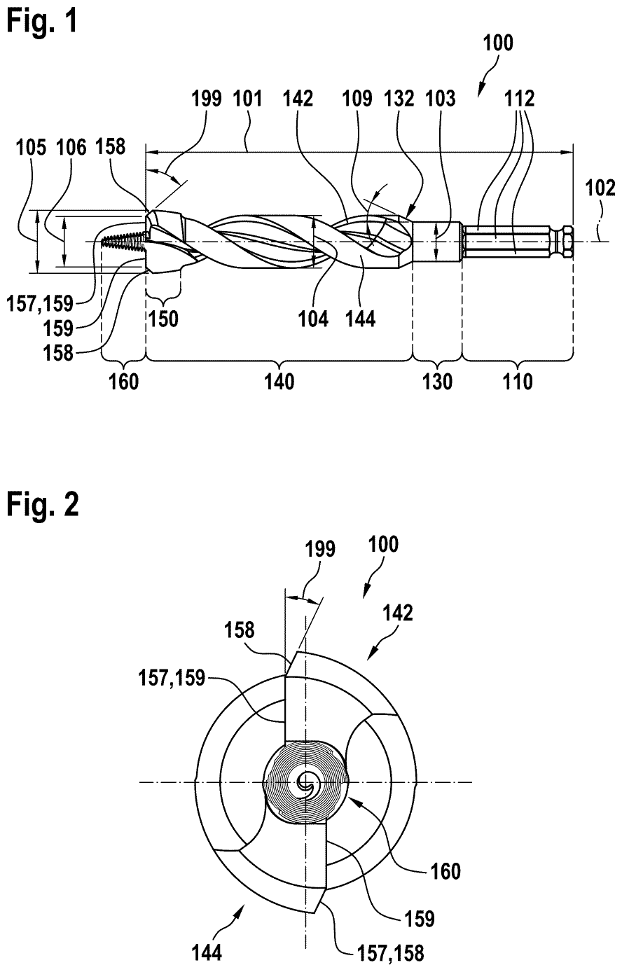

FIG. 1 shows an exemplary drill 100 having a longitudinal central axis 102 and a clamping portion 110 for a rotationally fixed connection of the drill 100 to a tool holder of a hand-held power tool. The drill 100 is preferably formed as a wood drill. Preferably, the drill 100 has an overall length 101.

The clamping portion 110 is connected via a shaft portion 130 to a cutting portion 140. The shaft portion 130 preferably has a circular cross-section with a diameter 103.

The clamping portion 110 has six tangential flat portions 112, as an example in FIG. 1. It is noted that the clamping portion 110 may also have more or less than six flat portions 112. Furthermore, the clamping portion 110 may also be formed as a round shaft.

The cutting portion 140 forms a head portion 150 on an end facing away from the clamping portion 110. The cutting portion 140 preferably has a first material and the head portion 150 has a second material, wherein the two materials are different. Preferably, the second material comprises high-speed steel, high-strength carbon steel, and/or carbide. A centering portion 160 is preferably arranged on the head portion 150.

The head portion 150 has a cutting edge 157 having at least two interconnected portions 158, 159. Preferably, the cutting edge 157 has a strictly monotonic contour. For this purpose, a first portion 158 is preferably arranged at a predefined angle 199 to a second portion 159. Preferably, the predefined angle 199 is between 25 degrees and 45 degrees, preferably at 30 degrees. Preferably, the first portion 158 has a first diameter 105 and the second portion 159 has a second diameter 106. Preferably, the second diameter 106 is smaller than the first diameter 105. Preferably, the first portion 158 is arranged facing the clamping portion 110, and the second portion 159 is arranged facing the centering portion 160.

According to one embodiment, the head portion 150 is fixed to the cutting portion 140 via a weld joint 154. Preferably, the head portion 150 has a maximum outer diameter which illustratively corresponds to the first diameter 105 and preferably is at least 17 mm. Preferably, the maximum outer diameter 105 of the head portion 150 corresponds to an 11/16 inch diameter. Preferably, the maximum outer diameter 105 of the head portion 150 is greater than an outer diameter 103 of the shaft portion 130.

Preferably, the shaft portion 130 widens into the cutting portion 140 via a flat portion 132. A diameter 104 of the cutting portion 140 is greater than the diameter 103 of the shaft portion 130. Preferably, the flat portion 132 is arranged at an angle 109 to the longitudinal central axis 102. By way of example, the angle 109 is 25 degrees.

Preferably, the cutting portion 140 comprises at least two diametrically opposed cutters 142, 144. The cutting edge 157 is preferably associated with the cutters 142, 144, i.e., each cutter 142, 144 has a cutting edge 157.

FIG. 2 shows the drill 100 of FIG. 1 viewed from its front side. FIG. 2 illustrates the preferably two diametrically opposed cutters 142, 144, each with a cutting edge 157.

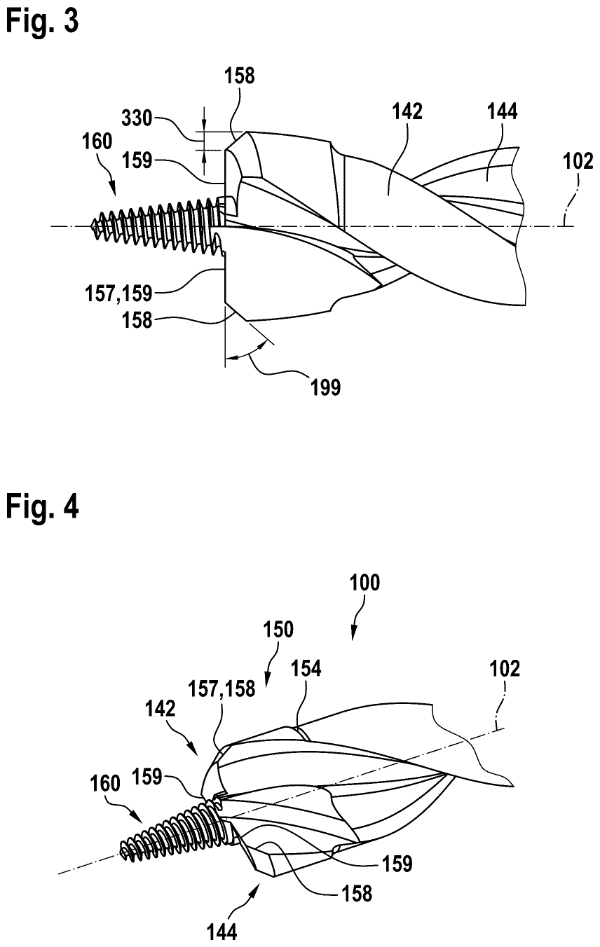

FIG. 3 shows the drill 100 of FIG. 1 and FIG. 2 and illustrates the head portion 150. By way of example, the first portion 158 of the cutting edge 157 has a height 330. The height 330 is illustratively arranged parallel to the longitudinal central axis 102 and perpendicular to the longitudinal central axis 102, and preferably has a value in the range of 1.5 mm to 4 mm.

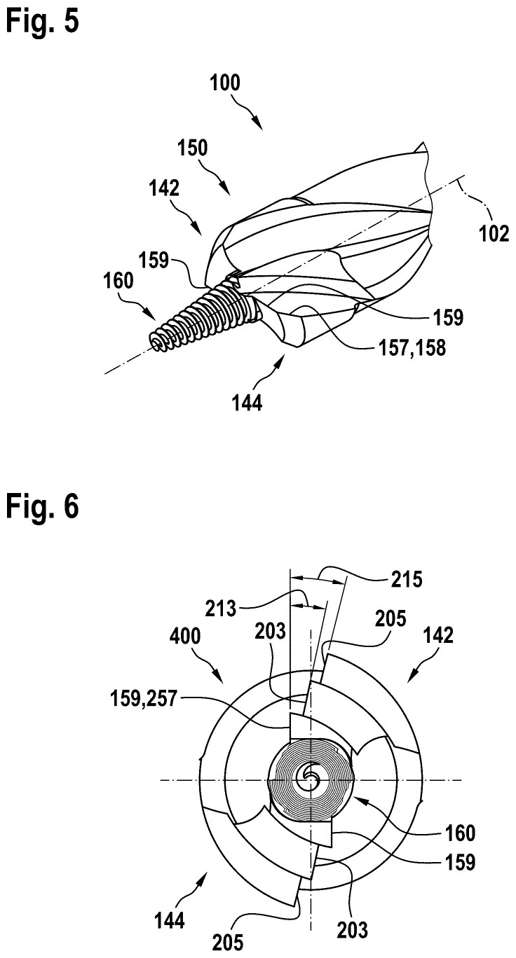

FIG. 4 and FIG. 5 show the drill 100 of FIG. 1 to FIG. 3, which is arranged rotated about the longitudinal axis 102. FIG. 4 and FIG. 5 illustrate the head portion 150 with the two cutters 142, 144 arranged diametrically opposite with a cutting edge 157 and the first and second portions 158, 159, respectively.

FIG. 6 shows an alternative embodiment 400 of the head portion 150 of FIG. 1 through FIG. 5, with a cutting edge 257 which illustratively has three portions 159, 203, 205. Preferably, the first portion 203 is arranged at a predefined angle 213 to the second portion 159 and the third portion 205 is arranged at a predefined angle 215 to the second portion 159. Preferably, the predefined angles 213, 215 are between 25 degrees and 45 degrees, preferably at 30 degrees.

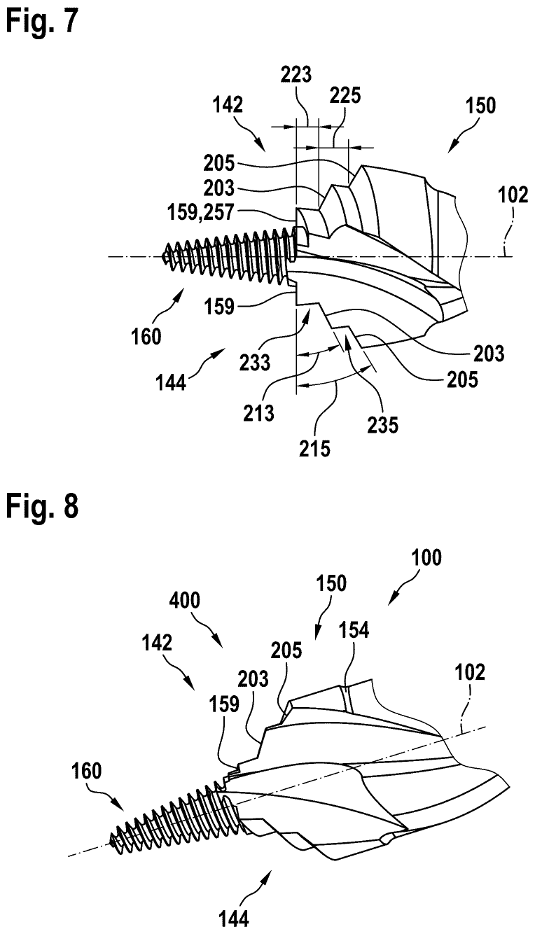

FIG. 7 shows the drill 100 of FIG. 6 and illustrates the embodiment 400 of the head portion 150. Here, the cutting edge 257 comprises a first step 233 and a second step 235. Preferably, the first step 233 is arranged between the first and second portions 203, 159 and the second step 235 is arranged between the first and third portions 203, 205. Here, the first step 233 has a first length 223 aligned along the longitudinal central axis 102 and the second step 235 has a second length 225 aligned along the longitudinal central axis 102. Preferably, the first length 223 is smaller than the second length 225. Preferably, the first length 223 is at least approximately 3 mm within predefined tolerances. Furthermore, the second length 225 is preferably between 4 mm and 5 mm within predefined tolerances.

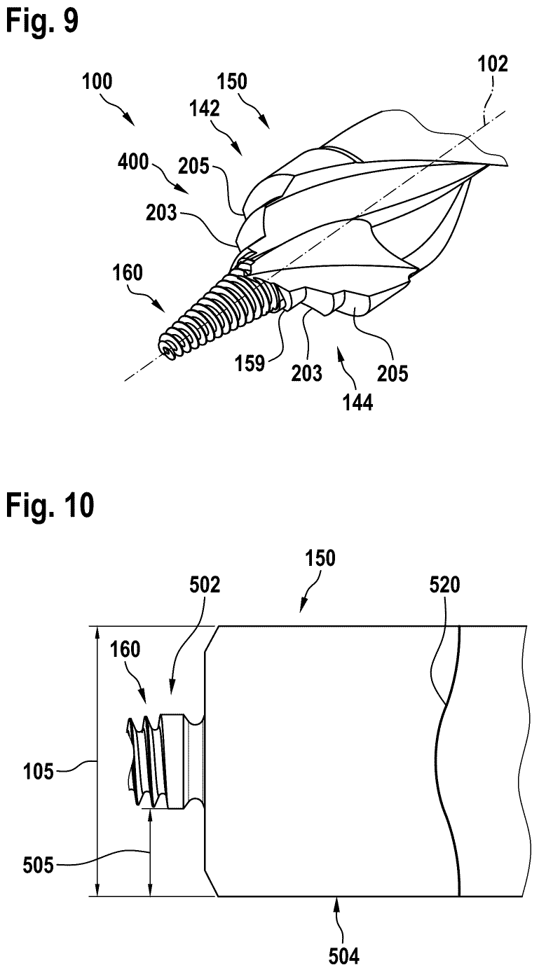

FIG. 8 and FIG. 9 show the drill 100 of FIG. 6 and FIG. 7, which is arranged rotated about the longitudinal axis 102. FIG. 8 and FIG. 9 illustrate the embodiment 400 of the head portion 150 with the two cutters 142, 144 arranged diametrically opposite with a cutting edge 257 and the first, second and third portions 203, 159, 205, respectively.

FIG. 10 shows an excerpt of the head portion 150 of the drill 100 from FIG. 1 to FIG. 5. FIG. 10 illustrates an outer circumference 502 of the centering portion 160, wherein the centering portion 160 is only shown in sections in FIG. 10. Furthermore, FIG. 10 illustrates an outer circumference 504 of the head portion 150. Furthermore, a predefined circumferential distance 505 is shown formed between the outer circumference 502 of the centering portion 160 and the outer circumference 504 of the head portion 150. Preferably, a ratio of the maximum outer diameter of the head portion 150 to the predefined circumferential distance 505 is smaller than 3.5. For this purpose, the head portion 150 has the maximum external diameter of at least 17 mm, as described above in FIG. 1.

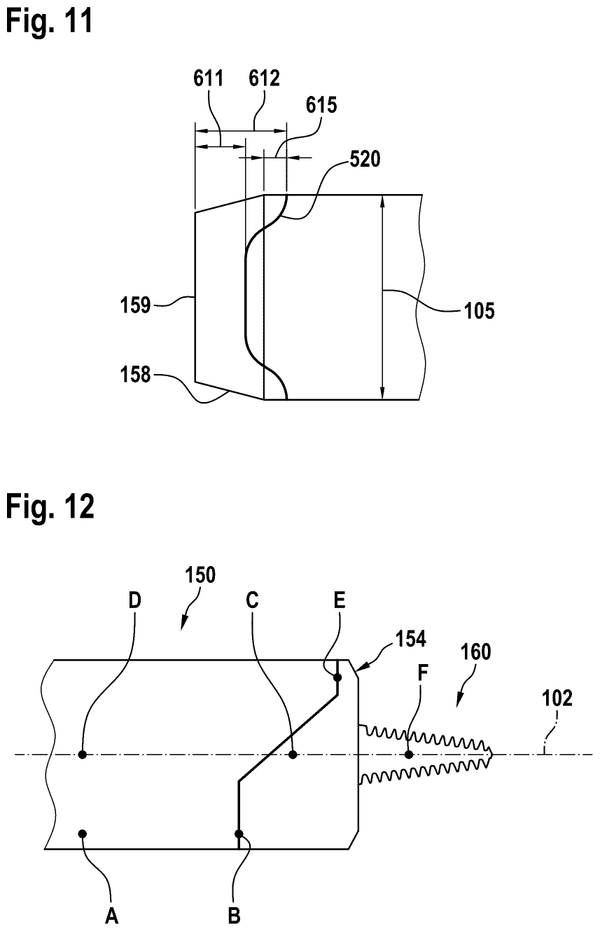

FIG. 11 shows an excerpt of the head portion 150 of FIG. 1 through FIG. 5 and illustrates a weld seam 520 of the weld joint 154 that fixes the head portion 150 to the cutting portion 140. Preferably, a predefined distance 611, 612, 615 is formed between the two portions 158, 159 of the cutting edge 157 and the weld seam 520 of the head portion 150 along the longitudinal central axis 102. The weld seam 520 illustratively has an arcuate shape, with one portion of the weld seam 520 formed in the first portion 158 and another portion of the weld seam 520—illustratively on the right in FIG. 11—formed facing the cutting portion 140 adjacent the first portion 158.

Preferably, a minimum distance 611 and a maximum distance 612 are formed between the second portion 159 of the cutting edge 157 and the weld seam 520. Furthermore, a distance 615 is preferably formed between the illustrative right end of the first portion 158 and the weld seam 520. Preferably, a ratio of the predefined distance 611, 612, 615 to the maximum outer diameter of the head portion 150 of FIG. 1 to FIG. 5 ranges from 0.01 to 1.5, for example.

FIG. 12 shows the head portion 150 of FIG. 1 through FIG. 5 with exemplary measurement points A through F during hardness measurement using a micro-hardness test. The first material is provided in the area of the measurement points A and D, and the second material is provided in the area of the remaining measurement points. According to one embodiment, the first material is C 60 and the second material is HS 6-5-2.

As an example, the measurement results in an average hardness value (in HV 0.5) of 299 at position A and 303 at position D. At measurement points B, C and E, which lie along the first portion 158 of the cutting edge 157, the average hardness values are 827 (B), 849 (C), and 857 (E). The measurement point F is arranged in the area of the centering portion 160 and an average hardness value of 823 is measured here.

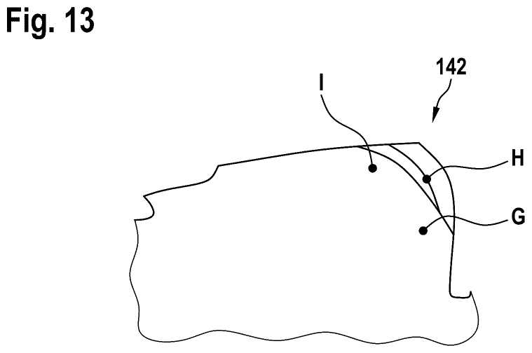

FIG. 13 shows three exemplary measurement points G, H, I of the cutter 142 of FIG. 1 to FIG. 5. The cutter 142 comprises the second material HS 6-5-2 analogously to FIG. 12. An average hardness value of 823 is measured at measurement point G, 827 at measurement point H and 824 at measurement point I. The above-mentioned average hardness values are exemplary only and are not intended as a limitation of the present invention.

1. A drill having a longitudinal central axis and comprising:
a clamping portion configured for a rotationally fixed connection to a tool holder;
a shaft portion;
a cutting portion that forms a head portion on an end of the drill facing away from the clamping portion; and
a centering portion arranged on the head portion,
wherein the clamping portion is connected via the shaft portion to the cutting portion,
wherein the head portion has a cutting edge with at least two interconnected portions,
wherein a first portion of the at least two interconnected portions is arranged at a predefined angle to a second portion of the at least two interconnected portions,
wherein the first portion has a first diameter and the second portion has a second diameter, the second diameter being smaller than the first diameter, and
wherein the first portion is arranged facing the clamping portion, and the second portion is arranged facing the centering portion.

2. The drill according to claim 1, wherein the cutting portion comprises a first material and the head portion comprises a second material that is different from the first material.

3. The drill according to claim 2, wherein the second material comprises high-speed steel, high-strength carbon steel, and/or carbide.

4. The drill according to claim 1, wherein the head portion is fixed to the cutting portion via a weld joint.

5. The drill according to claim 1, wherein:
a predefined circumferential distance is defined between an outer circumference of the centering portion and an outer circumference of the head portion, and
a ratio of a maximum outer diameter of the head portion to the predefined circumferential distance is smaller than 3.5.

6. The drill according claim 1, wherein the first portion has a height defined perpendicular to the longitudinal central axis, the height being in a range of from 1.5 mm to 4 mm.

7. The drill according to claim 1, wherein the head portion has a maximum outer diameter of at least 17 mm.

8. The drill according to claim 1, wherein:
the cutting edge comprises the first portion, the second portion and a third portion of the at least two interconnected portions, and
the first portion is arranged at a first predefined angle to the second portion and the third portion is arranged at a second predefined angle to the second portion.

9. The drill according to claim 8, wherein:
the cutting edge comprises a first step, which is arranged between the first and second portions, and a second step, which is arranged between the first and third portions, and
the first step has a first length aligned along the longitudinal central axis and the second step has a second length aligned along the longitudinal central axis, the first length being smaller than the second length.

10. The drill according to claim 1, wherein a maximum outer diameter of the head portion is greater than an outer diameter of the shaft portion.

11. The drill according to claim 1, wherein the drill is a wood drill.
